(19) United States
(12) Patent Application Publication
(10) Pub. No.: US 2007/0048472 A1
(43) Pub. Date: Mar. 1, 2007

(54) Polymeric pipe and method of making a polymeric pipe

(76) Inventors: Rajendra K. Krishnaswamy, Bartlesville, OK (US); David C. Rohlfing, Bartlesville, OK (US)

Correspondence Address: CHEVRON PHILLIPS CHEMICAL COMPANY, 5700 GRANITE PARKWAY, SUITE 330, PLANO, TX, 75024-6616, US

(21) Appl. No.: 11/215,500

(22) Filed: Aug. 30, 2005

(51) Int. Cl. B32B 27/08

(52) U.S. Cl. 428/35.7; 525/387; 525/333.7

(57) ABSTRACT

A method for making a polyethylene pipe, the method comprising preparing a polymer by adding greater than 0 and less than about 1000 ppm peroxide to a polyethylene resin and forming the polymer into a pipe. Polyethylene comprising greater than 0 and less than about 1000 ppm peroxide and having a tensile modulus of about equal to or greater than about 90% of the tensile modulus of an otherwise same polymer without peroxide. A uniaxially oriented polyethylene pipe comprising greater than 0 and less than about 1000 ppm peroxide.

### FIELD OF THE INVENTION

The present disclosure relates to polymeric pipe having a peroxide additive and more specifically to a uniaxially oriented polyethylene pipe having a peroxide additive.

### BACKGROUND OF THE INVENTION

The use of polymeric pipes rather than metal pipes to transport fluids may be advantageous for several reasons. For example, polymeric pipes may be relatively lighter weight, more corrosion resistant, more thermally and electrically insulative, tougher, more durable and more easily shaped during manufacture. However, generally, metal pipes may be stiffer than plastic pipes. High-density polyethylene (HDPE) pipes have been extensively employed for the transportation of natural gas for many decades now. The primary performance requirements for pressurized gas pipes are stiffness, resistance to slow crack growth (SCG) and low-temperature impact toughness. Cross-linking (using either peroxides, radiation, etc.) of HDPE pipes is a generally accepted practice in the gas pipe industry because of the improvements in SCG resistance and impact toughness. However, the conventional means of cross-linking leads to a reduction in polymer or pipe density that translates to lower stiffness. Therefore, there exists a need for pipe resins that offer a good balance between stiffness, SCG resistance and impact toughness.

### SUMMARY OF THE INVENTION

Disclosed herein is a method for making a polyethylene pipe, the method comprising preparing a polymer by adding greater than 0 and less than about 1000 ppm peroxide to a polyethylene resin and forming the polymer into a pipe. For purposes of the invention, the polyethylene resin can be a blend of two or more polyethylene resins.

Further disclosed herein is polyethylene comprising greater than 0 and less than about 1000 ppm peroxide and having a tensile modulus of about equal to or greater than about 90% of the tensile modulus of an otherwise same polymer without peroxide.

Further disclosed herein is a uniaxially oriented polyethylene pipe comprising greater than 0 and less than about 1000 ppm peroxide.

### BRIEF DESCRIPTION OF THE DRAWINGS

FIG. 1 represents a flow diagram of polymeric pipe preparation.

FIG. 2 is a graphical representation of the Charpy impact energy as a function of temperature.

### DETAILED DESCRIPTION OF THE INVENTION

Disclosed herein is a method of making polyethylene pipes. The method comprises preparing a polyethylene composition and forming the polymer into a pipe. In an aspect, the polyethylene composition comprises a polymer resin and a peroxide. Unless otherwise specified, the amounts given herein also represent the weight contribution of each component to the polyethylene composition used for making the polymeric pipe as well as the polymeric pipe itself.

The polymer resin may comprise a homopolymer, a copolymer, or blends thereof. In an aspect, the resin is a copolymer comprised of a polymer of ethylene with one or more comonomers such as alpha olefins. In an alternative aspect, the resin is a polymer of ethylene (PE), alternatively a low-density polyethylene (LDPE) alternatively, a linear low-density polyethylene (LLDPE), alternatively an ultra-low density polyethylene (ULDPE), alternatively a high-density polyethylene (HDPE), alternatively a medium-density polyethylene (MDPE). As used herein, the term polyethylene resin refers to polyethylene in any form prior to the addition of peroxide, including a polyethylene blend.

Methods for the preparation of the disclosed polymers are known to one skilled in the art. Suitable polymerization methods include Cr based, Ziegler-Natta, or metallocene catalysis or free radical vinyl polymerization. For example, the polymerization may be carried out using a plurality of stirred tank reactors either in series, parallel, or combinations thereof. Different reaction conditions may be used in the different reactors. Alternatively, the polymerization is conducted in a loop reactor using slurry polymerization. Within the loop reactor, the polymerization catalyst and the cocatalyst are suspended in an inert diluent and agitated to maintain them in suspension throughout the polymerization process. The diluent is a medium in which the polymer being formed does not readily dissolve. Diluents may be utilized as deemed appropriate by one with ordinary skill in the art. The slurry polymerization conditions are selected to ensure that the polymer being produced has certain desirable properties and is in the form of solid particles. The polymerization is desirably carried out below a temperature at which the polymer swells or goes into solution. For example, the polymerization temperature may be in the range of from about 85° C. to about 110° C. Specific methods, catalysts and conditions for the preparation of polyolefins such as polyethylene are disclosed in U.S. Pat. Nos. 4,424,341, 4,501,855, 4,613,484, 4,589,957, 4,737,280, 5,597,892, and 5,575,979, each of which is incorporated by reference herein in its entirety.

Various methods are known in the art for making polyethylene blends for use in the present invention. Such methods can include any physical mixing process, such as tumble blending of two or more resins in a mixer, for example, a Banbury mixer. Alternately, blends can be made in a single reactor, either by adding multiple components, or by multiple catalyst feeds into the reactor. In another aspect, blends can be made in parallel reactors and the resins combined somewhere downstream of the reactor. Blends are also made in reactors in series. For purposes of explanation, tumble blending is used to describe the present invention. Blends can also be made by extrusion blending where the mixing in the extruder is used to blend the resins.

In an aspect, the polyethylene resin has a density of greater than about 0.946 g/cc and a high load melt index (HLMI) of less than about 20.0 g/10 min. An example of a suitable resin includes without limitation, MARLEX® 9346 polyethylene resin available from Chevron Phillips Chemical Company LP of The Woodlands, Tex. In an aspect, a suitable PE (e.g., MARLEX® 9346 resin) has about the physical properties set forth in Table I:

TABLE I

| Nominal Physical | | | | | |
|---|---|---|---|---|---|
| Properties | English | | SI | | Method |
| Density | — | | 0.947 | g/cm³ | ASTM D1505 |
| Flow Rate (HLMI, | — | | 11.0 | g/10 min | ASTM D1238 |
| 190/21.6) | | | | | |
| Tensile Strength at | 3,200 | psi | 22 | MPa | ASTM D638 |
| Yield, 2 in/min, | | | | | |
| Type IV bar | | | | | |
| Elongation at | 800% | | 800% | | ASTM D638 |
| Break, 2 in/min, | | | | | |
| Type IV bar | | | | | |
| Flexural Modulus, | 130,000 | psi | 900 | MPa | ASTM D790 |
| 2% Secant - 16.1 | | | | | |
| span: depth, 0.5 | | | | | |
| in/min | | | | | |
| PENT Slow Crack | >1,000 | h | >1,000 | h | ASTM F1473 |
| Growth | | | | | |
| Brittleness | <−103° | F. | <−75° | C. | ASTM D746 |
| Temperature, Type | | | | | |
| A, Type I specimen | | | | | |

As disclosed, the polymeric composition comprises a polymer of ethylene and a peroxide. In an aspect, a suitable peroxide is any peroxide chemically compatible with the polymeric composition and capable of imparting the desired properties. In some aspects, organic peroxides may be used as an additive; alternately, succinic acid peroxide, benzoyl peroxide, t-butyl peroxy-2-ethyl hexanoate, p-chlorobenzoyl peroxide, t-butyl peroxy isobutylate, t-butyl peroxy isopropyl carbonate, t-butyl peroxy laurate, 2,5-dimethyl-2,5-di(benzoyl peroxy)hexane, t-butyl peroxy acetate, di-t-butyl diperoxy phthalate, t-butyl peroxy maleic acid, cyclohexanone peroxide, t-butyl peroxy benzoate, dicumyl peroxide, 2,5-dimethyl-2,5-di(t-butyl-peroxy)hexane, t-butyl cumyl peroxide, t-butyl hydroperoxide, di-t-butyl peroxide, 2,5-dimethyl-2,5-di(t-butylperoxy)hexyne-3, and alpha,alpha′-bis-t-butylperoxy-1,4-diisopropylbenzene may be used as an additive; alternately, 2,5-dimethyl-2,5-di(t-butylperoxy) hexane; alternately, any combination of or plurality of the aforementioned peroxides.

Additionally, it may be advantageous to use a peroxide which has an initiation or activation temperature greater than the melt temperature of the base polyethylene, but lower than the decomposition temperature of the base polyethylene, e.g., from about 140° C. to about 230° C., or in an aspect about 210° C. The initiation or activation temperature is the temperature at which the peroxide begins reacting with the polyethylene. The initiation temperature of the peroxide may be in the range high enough such that polyethylene-peroxide mixture can be heated sufficiently during mixing to evenly disperse the peroxide in the polyethylene, but below the decomposition temperature of the polyethylene.

The peroxides may be added in alternative amounts of greater than 0 and less than about 1000 parts per million (ppm) based on weight of polymeric composition, from about 20 to about 900 ppm, from about 50 to about 800 ppm, from about 100 to about 700 ppm, from about 100 to about 600 ppm, from about 100 to about 500 ppm, from about 100 to about 400 ppm, from about 100 to about 300 ppm, or from about 100 to about 200 ppm.

The polymeric composition may include other additives as known to those skilled in the art. Examples of additives include, but are not limited to, antistatic agents, colorants, stabilizers, nucleators and combinations thereof. In an aspect, the polymeric composition comprises carbon black. In another aspect, the polymeric composition is substantially free of carbon black. As used herein, substantially free of carbon black means that carbon black is not present (i.e., is absent from) or is present in such low amounts as to not materially affect the performance of the pipe. In an aspect, the polymeric composition comprises, in the alternative, less than about 10,000; 1,000; 100; 10; or 1 ppm by weight carbon black.

In an aspect, the polymeric compositions disclosed are used to fabricate end-use articles such as pipe. The peroxide can be added to the polyethylene resin prior to or during manufacture of the pipe. In an aspect, the polyethylene pipes are uniaxially oriented during manufacture. Methods and conditions for orienting pipe are known to one skilled in the art.

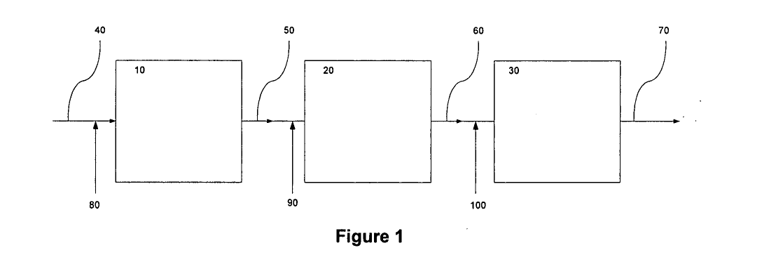

FIG. 1 illustrates an aspect of a process for preparing the uniaxially oriented, polymeric pipe described herein. Polyethylene fluff from a polymerization reactor is fed via feedstream 40 to a tumble blending process 10, from which a blended polymer is fed via stream 50 to a pelletization process 20, from which a pelletized polymer is fed via stream 60 to an extrusion process 30, from which a final product such as an extruded, uniaxially oriented pipe is recovered via line 70. The tumble blending process 10, pelletization process 20, and extrusion process 30 may be carried out as known to those skilled in the art. Other suitable methods of forming or making PE pipe, including but not limited to extrusion and injection molding can be used to make the polymeric pipe. Peroxide as disclosed herein may be added via stream 80 during tumble blending 10, added via stream 90 during pelletization 20, added via stream 100 during extrusion 30, or any combinations thereof. While peroxide streams are shown as additives to feed streams 40, 50, and 60, respectively, it should be understood that the peroxide can be added directly into the processing units 10, 20, and 30, respectively. Additionally and/or alternatively, peroxide can be added to the resin during other steps in the manufacturing process.

By way of example only, peroxides such as 2,5-dimethyl-2,5-di(t-butylperoxy) hexane, may be added via preparation of a master batch with the polymer or other carrier liquid such as mineral oil, added to the neat resin at extrusion, or added separately prior to manufacture of the pipe by an end user. During manufacture of plastic pipes, for example by extrusion, a uniaxial orientation may be produced by exerting axial forces on the plastic during extrusion (e.g., stretching the pipe in the direction of the axial flow path of the pipe as the pipe exits the extruder). Thus, there may be formed a uniaxially oriented polyethylene pipe.

Without being bound to any particular theory, it is expected that the addition of peroxides to the resin will produce a pressure pipe with a minor amount of crosslinking between the branches and/or increase the amount of long chain branching (LCB) in the polymer. This minor crosslinking and/or increased LCB are believed to produce a greater resistance to slow crack growth and impact toughness without a noticeable decrease in stiffness or density.

Tensile modulus (also referred to as Young's modulus) is the ratio of stress to strain (i.e., slope) within the elastic region of the stress-strain curve (prior to the yield point). Test articles of polymer produced in accordance with the present disclosure may have a tensile modulus of greater than about 1200 MPa, alternatively from about 1200 MPa to about 1400 MPa, according to ASTM D638. In an aspect, a polymer produced in accordance with the present disclosure (e.g., containing less than about 1000 ppm of peroxide) has a tensile modulus of greater than or equal to about 90% of the tensile modulus of an otherwise same polymer without peroxide. In an aspect, the density of the polyethylene resin used to produce the article (e.g., pipe) is about equal to the density of the polyethylene resin prior to the addition of the peroxide.

The Pennsylvania Edge Notch Tensile (PENT) test is a measure of an article's resistance to slow crack growth. Test articles of polymer produced in accordance with the present disclosure may have a PENT to slow crack growth fracture of greater than about 1200 hours, alternatively greater than about 2000 hours, alternatively, greater than about 3000 hours, according to ASTM F1473. In an aspect, the polymer produced in accordance with the present disclosure (e.g., containing less than about 1000 ppm of peroxide) has a PENT slow crack growth that is at least about 50% greater, alternatively at least about 75% greater, alternatively at least about 90% greater, alternatively at least about 100% greater, alternatively at least about 125% greater, alternatively at least about 150% greater than the PENT slow crack growth of an otherwise same polymer without peroxide.

Charpy impact energy is a measure of an article's impact toughness. Test articles of polymer produced in accordance with the present disclosure may have a Charpy impact energy of greater than about 0.35 J, alternatively equal to or greater than about 0.4 J, alternatively equal to or greater than about 0.45 J, alternatively equal to or greater than about 0.5 J, according to ASTM F2231 razor-notched Charpy impact test at room temperature. In an aspect, the polymer produced in accordance with the present disclosure (e.g., containing less than about 1000 ppm of peroxide) has a Charpy impact energy that is at least about 10% greater, alternatively at least about 20% greater, alternatively at least about 30% greater, alternatively at least about 40% greater, alternatively at least about 50% greater than the Charpy impact energy of an otherwise same polymer without peroxide.

### EXAMPLES

In each of the following examples, 1-8 listed in Table I, commercially produced Chevron Phillips Chemical MARLEX® 9346 pellets (a HDPE) comprising no carbon black served as the base polyethylene. The MARLEX® 9346 HDPE pellets were tumble blended for several minutes with a masterbatch peroxide solution. The masterbatch peroxide solution is a mixture containing 90 wt. % mineral oil and 10 wt. % 2,5-dimethyl-2,5-di(t-butylperoxy) hexane as peroxide. The masterbatch was added in an amount sufficient to yield an amount of the 2,5-dimethyl-2,5-di(t-butylperoxy) in ppm by weight of the polymeric composition as listed in the left column of Table II (e.g., 20 ppm, 60 ppm, etc.). The tumbled mixture was then extruded using a PRISM™ twin-screw extruder and pelletized at about 220° C. For physical property measurements, the pellets were compression molded into plaques via slow-cooling from the melt state. The physical properties were tested according to ASTM standards as indicated in the heading for each column. Tensile tests were conducted using an INSTRON® tensile tester according to ASTM D638 (using ASTM Type IV Specimens) using a crosshead speed of 51 mm/min at room temperature. Molecular weight data was measured via GPC. The test results are listed in Table 1. It is expected that the results of these tests on the compression-molded specimens are indicative of the performance of a pressure pipe of the same composition.

TABLE II

| | Density | | | Natural | Tensile | Charpy | | Molec- | | | | |
|---|---|---|---|---|---|---|---|---|---|---|---|---|
| | (g/cc) | | Tensile | Draw | Stress | Impact | Molec- | ular | | | | |
| | from | | Modulus | Ratio (% | at Break | Energy (J) | ular | weight | Zero-Shear | | | PENT |
| | DSC | | (MPa) | Extension) | (MPa) | (at room | weight | distri- | Viscocity | Relaxation | | (hours) |
| Example | heat of | ppm | ASTM | ASTM | ASTM | temperature) | M_{w} | bution | (η₀) | time | | ASTM |
| No. | fusion | peroxide | D638 | D638 | D638 | ASTM F2231 | (kg/mol) | M_{w}/Mₙ | (Pa · s) | (τ_{η}) (s) | a | F1473 |
| 1 | 0.9479 | 0 | 1409 | 619.0 | 29.7 | 0.34 | 338 | 34 | 4.39 × 10⁷ | 6.46 | 0.11 | 1214 |
| 2 | 0.9476 | 20 | 1389 | 634.8 | 23.8 | 0.38 | 324 | 45 | 1.75 × 10⁸ | 16.9 | 0.10 | 1922 |
| 3 | 0.9471 | 60 | 1424 | 594.8 | 28.3 | 0.41 | 304 | 49 | 9.67 × 10⁹ | 239 | 0.07 | 2293 |
| 4 | 0.9469 | 140 | 1379 | 586.9 | 32.2 | 0.42 | 308 | 34 | 1.87 × 10¹¹ | 2080 | 0.06 | 2164 |
| 5 | 0.9475 | 200 | 1354 | 571.4 | 29.6 | 0.51 | 312 | 33 | 5.50 × 10¹⁴ | 6.47 × 10⁵ | 0.04 | 3277 |
| 6 | 0.9468 | 400 | 1312 | 540.5 | 23.4 | 0.44 | 257 | 36 | 6.19 × 10¹⁶ | 1.01 × 10⁸ | 0.04 | >7000 |
| 7 | | 1000 | 1187 | — | 18.3 | 0.45 | 232 | 34 | 4.36 × 10¹⁹ | 2.80 × 10¹¹ | 0.04 | |
| 8 | | 6000 | 986 | — | 19.4 | 0.52 | 159 | 30 | 1.55 × 10²⁰ | 1.60 × 10¹³ | 0.05 | |

The melt rheology of the polymers was characterized by performing dynamic oscillatory measurements at 190° C. (using an ARES rheometer) and the resulting data (|η*| vs. ω) were fitted to the Carreau-Yasuda (CY) model:

$$\vert {η}^{*} ( ω ) \vert = {{η}_{0} [ 1 + {( {τ}_{η} ω )}^{a} ]}^{\frac{n - 1}{a}} \qquad [ 1 ]$$

where, |η*(ω)| is the scalar magnitude of the complex viscosity, η₀ is the zero-shear viscosity, ω is the angular frequency, τ_{η} is the characteristic viscous relaxation time, a is a parameter that is inversely related to the breadth of the transition from Newtonian to power-law behavior, and, the power law constant, n, fixes the final slope of the viscosity at high frequencies. To facilitate model fitting, the power law constant is held at a constant value of 0.

Details of the significance and interpretation of the CY model and derived parameters may be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong and O. Hasseger, Dynamics of Polymeric Liquids, Volume 1, Fluid Mechanics, 2nd Edition, John Wiley & Sons (1987), each of which is incorporated by reference herein in its entirety.

Where peroxide is added in amounts less than about 1000 ppm (i.e., Examples 2-6), the tensile modulus remains about equal to or is reduced very little in comparison to the base resin of Example 1. Furthermore, the Charpy impact energy and PENT of Examples 2-6 are improved over those of the base resin in Example 1. The Examples indicate that the addition of small amounts of peroxide (e.g., less than about 1000 ppm) can improve both the resistance to slow crack growth (i.e., PENT) and the impact toughness (i.e., Charpy) without sacrificing stiffness (i.e., tensile modulus).

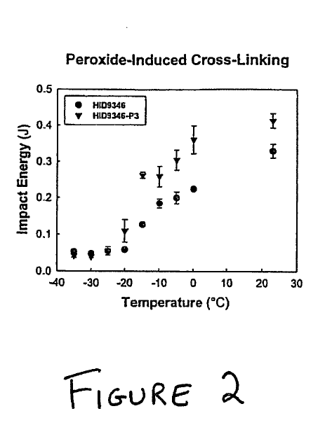

As can be seen in FIG. 2, the ductile-brittle transition temperature (i.e., the temperature at which the pipe becomes brittle and the impact energy drops dramatically) of the peroxide/polyethylene blend of Example 4 is about −25° C. while the ductile-brittle transition temperature of the Example 1, polyethylene without peroxide, is about −20° C. Furthermore, the impact energy for Example 4 is greater than that for Example 1 at temperatures above the ductile-brittle transition temperature. Thus, it is also expected that the peroxide/polyethylene blends claimed and disclosed herein can have a greater useful range of service temperatures than the corresponding polyethylene untreated by peroxide before they become brittle and subject to cracking.

Without further elaboration, it is believed that one skilled in the art can, using the description herein, utilize the present invention to its fullest extent. While preferred aspects of the invention have been shown and described, modifications thereof can be made by one skilled in the art without departing from the spirit and teachings of the invention. The aspects and examples described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present invention. Thus, the claims are a further description and are an addition to the preferred aspects of the present invention. The disclosures of all patents, patent applications, and publications cited herein are hereby incorporated by reference, to the extent that they provide exemplary, procedural or other details supplementary to those set forth herein.

1. A method for making a polyethylene pipe, the method comprising preparing a polymer by adding greater than 0 and less than about 1000 ppm peroxide to a polyethylene resin; forming the polymer into a pipe; and stretching the pipe to enhance its uniaxial orientation.

2. The method of claim 1 wherein from about 100 to about 800 ppm peroxide is added to the polyethylene resin.

3. The method of claim 1 wherein from about 100 to about 500 ppm peroxide is added to the polyethylene resin.

4. The method of claim 1 wherein from about 100 to about 300 ppm peroxide is added to the polyethylene resin.

5. The method of claim 1 wherein the peroxide comprises organic peroxide.

6. The method of claim 1 wherein the peroxide comprises succinic acid peroxide, benzoyl peroxide, t-butyl peroxy-2-ethyl hexanoate, p-chlorobenzoyl peroxide, t-butyl peroxy isobutylate, t-butyl peroxy isopropyl carbonate, t-butyl peroxy laurate, 2,5-dimethyl-2,5-di(benzoyl peroxy)hexane, t-butyl peroxy acetate, di-t-butyl diperoxy phthalate, t-butyl peroxy maleic acid, cyclohexanone peroxide, t-butyl peroxy benzoate, dicumyl peroxide, 2,5-dimethyl-2,5-di(t-butyl-peroxy)hexane, t-butyl cumyl peroxide, t-butyl hydroperoxide, di-t-butyl peroxide, 2,5-dimethyl-2,5-di(t-butylperoxy)hexyne-3, alpha,alpha′-bis-t-butylperoxy-1,4-diisopropylbenzene, any plurality thereof, or any combination thereof.

7. The method of claim 1 wherein the peroxide comprises 2,5-dimethyl-2,5-di(t-butyl peroxy) hexane.

8. (canceled)

9. The method of claim 1 wherein the polymer has a tensile modulus of greater than about 1200 MPa per ASTM D638.

10. The method of claim 1 wherein the polymer has a tensile modulus of equal to or greater than about 90% of the tensile modulus of an otherwise same polymer without peroxide.

11. The method of claim 1 wherein the polymer has a PENT slow crack growth of greater than about 1200 hours per ASTM F1473.

12. The method of claim 1 wherein the polymer has a PENT slow crack growth that is at least about 50% greater than the PENT slow crack growth of an otherwise same polymer without peroxide.

13. The method of claim 1 wherein the polymer has a Charpy impact energy of greater than about 0.35 J per ASTM F2231.

14. The method of claim 1 wherein the polymer has a Charpy impact energy that is at least about 10% greater than the Charpy impact energy of an otherwise same polymer without peroxide.

15. The method of claim 1 wherein the polymer has a razor-notched Charpy ductile to brittle temperature of equal to or less than about −25° C.

16. Polyethylene comprising greater than 0 and less than about 1000 ppm peroxide and having a tensile modulus of about equal to or not less than about 90% of the tensile modulus of an otherwise same polymer without peroxide.

17. The polyethylene of claim 16 further having a PENT slow crack growth that is at least about 50% greater than the PENT slow crack growth of an otherwise same polymer without peroxide.

18. The polyethylene of claim 17 having a Charpy impact energy that is at least about 10% greater than the Charpy impact energy of an otherwise same polymer without peroxide.

19. The polyethylene of claim 18 having a razor-notched Charpy ductile to brittle temperature of equal to or less than about −25° C.

20. An enhanced uniaxially-oriented polyethylene pipe comprising greater than 0 and less than about 1000 ppm peroxide.
